(19) United States
(12) Patent Application Publication
(10) Pub. No.: US 2025/0061504 A1
(43) Pub. Date: Feb. 20, 2025

(54) ELECTRONIC FLEA MARKET SERVER, MANAGEMENT METHOD, AND RECORDING MEDIUM

(71) Applicant: Rakuten Group, Inc., Tokyo (JP)

(72) Inventors: Yuta SAITO, Tokyo (JP); Ryuichi Hayashi, Tokyo (JP); Binseop Ko, Tokyo (JP)

(73) Assignee: Rakuten Group, Inc., Tokyo (JP)

(21) Appl. No.: 18/804,761

(22) Filed: Aug. 14, 2024

(30) Foreign Application Priority Data
Aug. 16, 2023 (JP) 2023-132681

(51) Int. Cl. G06Q 30/0601; G06Q 30/0201

(52) U.S. Cl. CPC G06Q 30/0629; G06Q 30/0206

(57) ABSTRACT

A purchase history acquirer acquires of an electronic flea market server acquires a purchase history of a product purchased by a user on an electronic marketplace. In a case in which a product distribution code is not assigned to the product of the acquired purchase history, a market price acquirer acquires, on the basis of a product distribution code assigned to a similar product of the product of the purchase history, a market price of a used similar product, and estimates, on the basis of the market price of the used similar product, a market price of the used product of the product of the purchase history. An outputter outputs a message prompting listing, in the electronic flea market, of the product of the purchase history at the market price of the used product.

### CROSS-REFERENCE TO RELATED APPLICATIONS

This application claims the benefit of Japanese Patent Application No. 2023-132681, filed on Aug. 16, 2023, the entire disclosure of which is incorporated by reference herein.

### FIELD OF THE INVENTION

The present disclosure relates to an electronic flea market server, a management method, and a recording medium.

### BACKGROUND OF THE INVENTION

Technology is known that presents market prices to a user in order to prompt listing of products in an electronic flea market, internet auction, or the like. For example, Unexamined Japanese Patent Application Publication No. 2009-122780 describes a technology for acquiring market information of a used product in the second-hand market, adding the acquired market information to a recommendation that suggests transferring a product that the user purchased in the past to a third party, and sending the recommendation.

### SUMMARY OF THE INVENTION

There is a demand to present the user with the market price in an electronic flea market of a product purchased on an electronic marketplace in order to prompt the user to list, in the electronic flea market, the product purchased by the user on the electronic marketplace. However, there is a problem in that, in electronic marketplaces in which a variety of shops sell products, there are many products to which product distribution codes are not assigned, which makes it difficult to look up the market prices of such products.

The present disclosure is made with the view of the above situation, and an objective of the present disclosure is to provide an electronic flea market server, a management method, and a recording medium whereby it is possible to estimate the market price in an electronic flea market of a product that is purchased on an electronic marketplace and to which a product distribution code is not assigned, and to prompt listing of that product to the electronic flea market.

An electronic flea market server according to a first aspect of the present disclosure is an electronic flea market server that manages an electronic flea market, the electronic flea market server including one or more processors,
the one or more processors performing processing of:
acquiring, from an electronic marketplace server that manages an electronic marketplace, a purchase history of a product purchased by a user on the electronic marketplace;
acquiring a market price, in the electronic flea market, of a used product that is a used item of the product included in the acquired purchase history;
outputting a message prompting the user to list, in the electronic flea market, the product included in the acquired purchase history at the acquired market price of the used product; and
in a case in which a product distribution code is not assigned to the product included in the acquired purchase history,
acquiring, from the electronic marketplace server, a product distribution code assigned to a similar product that is similar to the product included in the acquired purchase history, acquiring, based on the acquired product distribution code, a market price of a used similar product that is a used item of the similar product, and estimating, based on the acquired market price of the used similar product, the market price of the used product of the product included in the acquired purchase history.

In the electronic flea market server according to the first aspect, the one or more processors performs processing of:
in a case in which the product distribution code is assigned to the product included in the acquired purchase history,
acquiring, based on the assigned product distribution code, the market price of the used product of the product included in the acquired purchase history.

In the electronic flea market server according to the first aspect,
the one or more processors performs processing of:
   in a case in which the product distribution code is assigned to the product purchased by the user on the electronic marketplace,
   acquiring, from the electronic marketplace server, a purchase history including the assigned product distribution code, and information about a purchase price and a purchase date of the product purchased by the user on the electronic marketplace, and
   in a case in which the product distribution code is not assigned to the product purchased by the user on the electronic marketplace,
   acquiring, from the electronic marketplace server, a purchase history including the product distribution code assigned to the similar product that is similar to the product purchased by the user on the electronic marketplace, and the information about the purchase price and the purchase date of the product purchased by the user on the electronic marketplace,

In the electronic flea market server according to the first aspect, the one or more processors performs processing of:
in a case in which the product distribution code is assigned to the product included in the acquired purchase history,
correcting, based on the purchase price and the purchase date, the acquired market price of the used product, and
in a case in which the product distribution code is not assigned to the product included in the acquired purchase history,
correcting, based on the purchase price and the purchase date, the acquired market price of the used similar product.

In the electronic flea market server according to the first aspect, the one or more processors performs processing of:
estimating a depreciation rate based on a selling price in the electronic marketplace of a new item of the product included in the acquired purchase history and the acquired market price of the used product, and
correcting the acquired market price of the used product based on the estimated depreciation rate, the purchase price, and the purchase date.

In the electronic flea market server according to the first aspect, the one or more processors performs processing of:
estimating a depreciation rate based on a selling price, in the electronic marketplace, of a new item of the similar product that is similar to the product included in the acquired purchase history and the acquired market price of the used similar product, and
correcting the acquired market price of the used similar product based on the estimated depreciation rate, the purchase price, and the purchase date.

A management method according to a second aspect of the present disclosure is a management method that an electronic flea market server that manages an electronic flea market performs, the method including:
acquiring, from an electronic marketplace server that manages an electronic marketplace, a purchase history of a product purchased by a user on the electronic marketplace;
acquiring a market price, in the electronic flea market, of a used product that is a used item of the product included in the acquired purchase history; and
outputting a message prompting the user to list, in the electronic flea market, the product included in the acquired purchase history at the acquired market price of the used product,
wherein
in the acquiring of the market price,
   in a case in which a product distribution code is not assigned to the product included in the acquired purchase history,
   a product distribution code assigned to a similar product that is similar to the product included in the acquired purchase history is acquired from the electronic marketplace server, a market price of a used similar product that is a used item of the similar product is acquired based on the acquired product distribution code, and the market price of the used product of the product included in the acquired purchase history is estimated based on the acquired market price of the used similar product.

A non-transitory computer-readable recording medium according to a third aspect of the present disclosure is a computer-readable recording medium on which is recorded a program for causing a computer that manages an electronic flea market to perform:
acquiring, from an electronic marketplace server that manages an electronic marketplace, a purchase history of a product purchased by a user on the electronic marketplace;
acquiring a market price, in the electronic flea market, of a used product that is a used item of the product included in the acquired purchase history;
outputting a message prompting the user to list, in the electronic flea market, the product included in the acquired purchase history at the acquired market price of the used product; and
in a case in which a product distribution code is not assigned to the product included in the acquired purchase history,
acquiring, from the electronic marketplace server, a product distribution code assigned to a similar product that is similar to the product included in the acquired purchase history, acquiring, based on the acquired product distribution code, a market price of a used similar product that is a used item of the similar product, and estimating, based on the acquired market price of the used similar product, the market price of the used product of the product included in the acquired purchase history.

The program may be stored on a non-transitory recording medium. The non-transitory recording medium can be distributed and sold independent from the computer. Here, the term “non-transitory recording medium” refers to a tangible recording medium. Examples of the non-transitory recording medium include compact disks, flexible disks, hard disks, optical magnetic disks, digital video disks, magnetic tape, and semiconductor memory. The term “transitory recording medium” means the transmission medium (the propagation signal) itself. Examples of transitory recording media include electronic signals, optical signals, and electromagnetic waves. Note that the term “temporary storage space” refers to space for temporarily storing data and programs. Examples of the temporary storage region include volatile memory such as random-access memory (RAM).

According to the present disclosure, an electronic flea market server, a management method, and a recording medium can be provided whereby it is possible to estimate the market price in an electronic flea market of a product that is purchased on an electronic marketplace and to which a product distribution code is not assigned, and to prompt listing of that product in the electronic flea market.

### BRIEF DESCRIPTION OF DRAWINGS

A more complete understanding of this application can be obtained when the following detailed description is considered in conjunction with the following drawings, in which:

FIG. 1 is a drawing illustrating the relationship between an electronic flea market server, an electronic marketplace server, and user terminals according to an embodiment;

FIG. 2 is a drawing illustrating the hardware configuration of the electronic flea market server according to the embodiment;

FIG. 3 is a drawing illustrating the functional configuration of the electronic flea market server according to the embodiment;

FIG. 4 is a drawing illustrating an example of a purchase history table according to the embodiment;

FIG. 5 is a drawing illustrating an example of a message according to the embodiment; and

FIG. 6 is a flowchart illustrating management processing according to the embodiment.

### DETAILED DESCRIPTION OF THE INVENTION

### 1. Overall Configuration

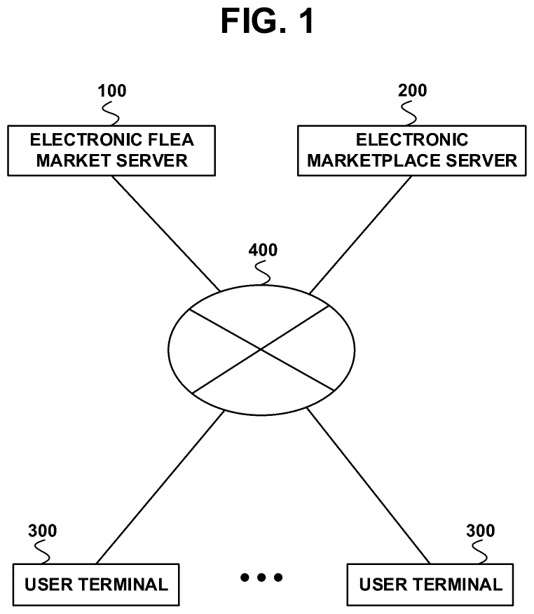

As illustrated in FIG. 1, an electronic flea market server 100 according to an embodiment of the present disclosure is communicably connected to an electronic marketplace server 200 and user terminals 300 across a computer communication network 400 such as the internet.

The electronic flea market server 100 is a server that manages an electronic flea market. In one example, the electronic flea market server 100 performs, in response to requests from the user terminals 300, providing of information and purchasing processing for products listed in the electronic flea market.

The electronic marketplace server 200 is a server that manages an electronic marketplace. In one example, the electronic marketplace server 200 performs, in response to requests from the user terminals 300, providing of information and purchasing processing for products being sold on the electronic marketplace. Additionally, the electronic marketplace server 200 manages purchase histories of user on the electronic marketplace.

Each user terminal 300 is a terminal of a user that uses the electronic flea market managed by the electronic flea market server 100 and the electronic marketplace managed by the electronic marketplace server 200. The user terminal 300 is, for example, a personal computer, a smartphone, a tablet computer, or the like. The user performs, via the user terminal 300, viewing of products listed in the electronic flea market, purchasing procedures of the products, and the like. Additionally, the user performs, via the user terminal 300, viewing of products being sold on the electronic marketplace, purchasing procedures of the products, and the like.

### 2. Hardware Configuration of Electronic Flea Market Server

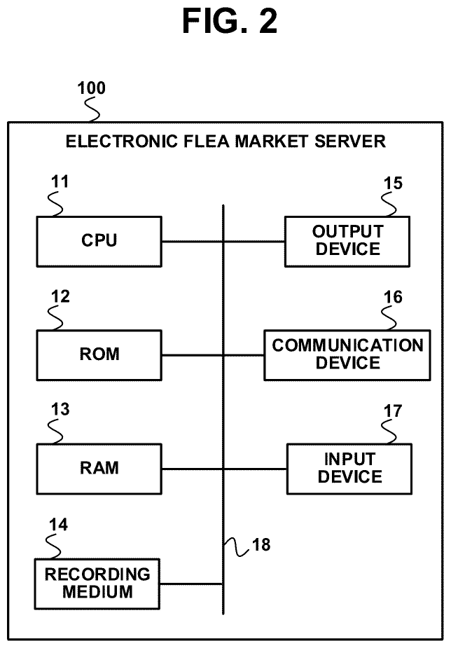

FIG. 2 is a block diagram illustrating the hardware configuration of the electronic flea market server 100.

As illustrated in FIG. 2, the electronic flea market server 100 includes a central processing unit (CPU) 11, a read-only memory (ROM) 12, a RAM 13, a recording medium 14, an output device 15, a communication device 16, and an input device 17. The various components are connected by a bus 18.

The CPU 11 controls the operations of the entire electronic flea market server 100, and is connected to and exchanges control signals and data with the various components.

An operating program and various types of data needed for the operation control of the entire electronic flea market server 100 are stored in the ROM 12.

The RAM 13 is a component for temporarily storing data and programs. In addition to the program and the data read out from the recording medium 14, data required for communicating and the like are held in the RAM 13.

The recording medium 14 is configured from a hard disk, a flash memory, or the like, and stores data to be processed by the electronic flea market server 100.

The output device 15 includes a display device such as a liquid crystal display (LCD) or the like, and an audio output device such as a speaker or the like. In one example, under the control of the CPU 11, the output device 15 outputs data output from the CPU 11.

The communication device 16 includes a communication interface for connecting the electronic flea market server 100 to the computer communication network 400 such as the internet or the like, and carries out exchanges with another information processing device or the like via the communication device 16.

The input device 17 includes an input device such as a button, a keyboard, a touch panel, a microphone, a camera, an optical scanner, or the like. The input device 17 receives an operation input from the user of the electronic flea market server 100, and outputs, to the CPU 11, a signal corresponding to the received operation input.

### 3. Functional Configuration of Electronic Flea Market Server of the Embodiment

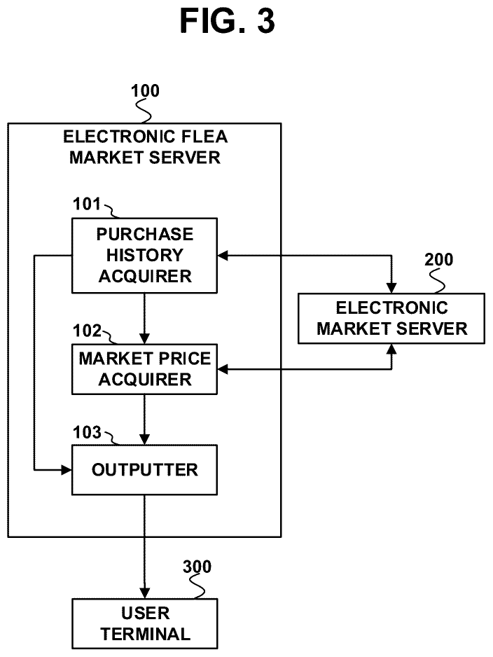

The functional configuration of the electronic flea market server 100 is described using FIG. 3.

The electronic flea market server 100 functionally includes a purchase history acquirer 101, a market price acquirer 102, and an outputter 103. In the present embodiment, the CPU 11 and the communication device 16 cooperate to function as the purchase history acquirer 101, the market price acquirer 102, and the outputter 103.

The purchase history acquirer 101 acquires, from the electronic marketplace server 200 that manages the electronic marketplace, a purchase history of products purchased by a user on the electronic marketplace.

The purchase history is a history of the products that the user has purchased on the electronic marketplace, and is managed by the electronic marketplace server 200. In one example, the electronic marketplace server 200 manages, as the purchase history, information about purchase prices and purchase dates of products that the user has purchased on the electronic marketplace. In a case in which a product distribution code is assigned to a product that the user has purchased on the electronic marketplace, the electronic marketplace server 200 manages, as the purchase history, the product distribution code assigned to the purchased product and, in a case in which a product distribution code is not assigned to a product that the user has purchased on the electronic marketplace, the electronic marketplace server 200 manages, as the purchase history, a product distribution code assigned to a similar product that is similar to the product that the user has purchased on the electronic marketplace.

The product distribution code is a code for identifying a product and, for example, is a Japanese Article Number (JAN) code, a unique code assigned by the electronic marketplace, or the like.

The similar product is a product that is similar to the product purchased by the user on the electronic marketplace and, for example, is a product defined arbitrarily as similar on the basis of various criteria such as category, manufacturer, shape, color, and the like.

In one example, in a case in which the product distribution code is assigned to a product P1 purchased by a user U1 on the electronic marketplace, the electronic marketplace server 200 manages, as the purchase history of the product P1 of the user U1, the product distribution code of the product P1, the purchase price of the product P1, and the purchase date of the product P1. Meanwhile, in a case in which the product distribution code is not assigned to a product P2 that a user U2 has purchased on the electronic marketplace, the electronic marketplace server 200 searches for a similar product that is similar to the product P2 and to which the product distribution code is assigned, and manages, as the purchase history of the product P2 of the user U2, the product distribution code of a similar product P3 found by the searching, the purchase price of the product P2, and the purchase date of the product P2.

Accordingly, in a case in which the product distribution code is assigned to the product purchased by the user on the electronic marketplace, the purchase history acquirer 101 acquires, from the electronic marketplace server 200, the purchase history including the assigned product distribution code, and information about the purchase price and the purchase date of the product purchased by the user on the electronic marketplace and, in a case in which the product distribution code is not assigned to the product purchased by the user on the electronic marketplace, the purchase history acquirer 101 acquires, from the electronic marketplace server 200, the purchase history including the product distribution code assigned to the similar product that is similar to the product purchased by the user on the electronic marketplace, and information about the purchase price and the purchase date of the product purchased by the user on the electronic marketplace.

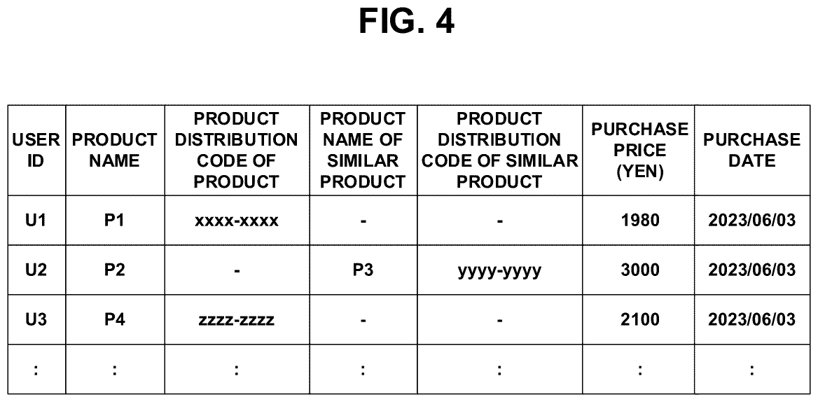

FIG. 4 illustrates an example of a table in which the information about the purchase history acquired by the purchase history acquirer 101 is registered. A user ID for identifying the user, a product name of the product purchased by the user, the product distribution code of the product purchased by the user, a product name of the similar product that is similar to the product purchased by the user, the product distribution code of the similar product, and the purchase price and the purchase date of the product purchased by the user are associated and registered in the purchase history table illustrated in FIG. 4. The record of the first row of the purchase history table indicates that the product distribution code “xxxx-xxxx” is assigned to the product P1 purchased by the user U1, that the purchase price of the product P1 is “1980 yen”, and that the product P1 was purchased on “Jun. 3, 2023.” The record of the second row of the purchase history table indicates that a product distribution code is not assigned to the product P2 purchased by the user U2 and the product distribution code “yyyy-yyyy” is assigned to the similar product P3 that is similar to the product P2, that the purchase price of the product P2 is “3000 yen”, and that the product P2 was purchased on “Jun. 3, 2023.” In one example, the purchase history table is stored in the recording medium 14 of the electronic flea market server 100.

The market price acquirer 102 acquires a market price, in the electronic flea market, of a used product that is a used item of the product included in the acquired purchase history.

The market price is a price at which a transaction is expected to be made at present when listed, and is determined on the basis of a price at which a transaction for the used product has been made in the past.

Here, in a case in which the product distribution code is assigned to the product included in the acquired purchase history, the market price acquirer 102 acquires, on the basis of the assigned product distribution code, the market price of the used product of the product included in the acquired purchase history.

For example, the product distribution code “xxxx-xxxx” is assigned to the product P1 included in the purchase history of the user U1 and, as such, the market price acquirer 102 searches, in the electronic flea market, for a used product of the product P1 to which the product distribution code “xxxx-xxxx” is assigned. Next, the market price acquirer 102 acquires the price at which a transaction was made for the used product of the product P1 specified by the searching. Then, in a case in which the market price acquirer 102 acquires a plurality of prices at which transactions have been made for the used product of the product P1, the market price acquirer 102 acquires, as the market price of the used product of the product P1, a statistical value such as a mean, median, mode, or the like of the prices at which the transactions were made, or a range of prices at which the transactions were made. Additionally, in a case in which the market price acquirer 102 acquires one price at which a transaction has been made for the used product of the product P1, the market price acquirer 102 acquires that price as the market price of the used product of the product P1.

In a case in which the product distribution code is not assigned to the product included in the acquired purchase history, the market price acquirer 102 acquires, from the electronic marketplace server 200, the product distribution code assigned to the similar product that is similar to the product included in the acquired purchase history, acquires, on the basis of the acquired product distribution code, a market price of a used similar product that is a used item of the similar product, and estimates, on the basis of the acquired market price of the used similar product, the market price of the used product of the product included in the acquired purchase history.

For example, the product distribution code is not assigned to the product P2 included in the purchase history of the user U2 and, as such, the market price acquirer 102 acquires the product distribution code “yyyy-yyyy” assigned to the similar product P3 that is similar to the product P2 included in the purchase history, and searches, in the electronic flea market, for a used similar product that is a used item of the similar product P3 to which the product distribution code “yyyy-yyyy” is assigned. Next, the market price acquirer 102 acquires the price at which a transaction has been made for the used similar product of the similar product P3 specified by the searching. Then, in a case in which the market price acquirer 102 acquires a plurality of prices at which transactions have been made for the used similar product of the similar product P3, the market price acquirer 102 acquires, as the market price of the used similar product of the similar product P3, a statistical value such as a mean, median, mode, or the like of the prices at which the transactions have been made, or a range of prices at which the transactions have been made. Additionally, in a case in which the market price acquirer 102 acquires one price at which a transaction was made for the used similar product of the similar product P3, the market price acquirer 102 acquires that price as the market price of the used similar product of the similar product P3. The market price acquirer 102 regards the market price of the used similar product of the similar product P3 as the market price of the used product of the product P2.

Note that a configuration is possible in which, in a case in which the product distribution code is assigned to the product included in the acquired purchase history, the market price acquirer 102 corrects the acquired market price of the used product on the basis of the purchase price and the purchase date.

Specifically, the market price acquirer 102 estimates a depreciation rate on the basis of a selling price, in the electronic marketplace, of a new item of the product included in the acquired purchase history, and the acquired market price of the used product, and corrects the acquired market price of the used product on the basis of the estimated depreciation rate, the purchase price, and the purchase date.

In one example, it is assumed that the current selling price of a new item of the product P1 is “2000 yen” in the electronic marketplace, the market price of a used product of the product P1 is “1280 yen” in the electronic flea market, a release date of the product P1 is “Dec. 10, 2021”, and a current date is “Aug. 1, 2023.” In this case, the market price acquirer 102 calculates the difference between the selling price of “2000 yen” and the market price of the used product of “1280 yen”, and divides the difference by a number of days “600” from the release date of “Dec. 10, 2021” to the current date of “Aug. 1, 2023” to obtain a daily depreciation rate of “1.2”. Moreover, since “60 days” have passed from the date of “Jun. 3, 2023” on which the user U1 purchased the product P1 to the current date of “Aug. 1, 2023”, the market price acquirer 102 sets, as the market price of the used product, a value of “1908 yen”, which is obtained by subtracting, from the price of “1980 yen” at which the user U1 purchased the product P1, a value obtained by multiplying the number of days of “60” by the depreciation rate of “1.2”.

Additionally, a configuration is possible in which, in a case in which the product distribution code is not assigned to the product included in the acquired purchase history, the market price acquirer 102 corrects the acquired market price of the used similar product on the basis of the purchase price and the purchase date.

Specifically, the market price acquirer 102 estimates the depreciation rate on the basis of a selling price, in the electronic marketplace, of a new item of the similar product that is similar to the product included in the acquired purchase history, and the acquired market price of the used similar product, and corrects the acquired market price of the used similar product on the basis of the estimated depreciation rate, the purchase price, and the purchase date.

In one example, it is assumed that the current selling price of a new item of the similar product P3 is “3200 yen” in the electronic marketplace, the market price of a used similar product of the similar product P3 is “2800 yen” in the electronic flea market, the release date of the similar product P3 is “Jan. 14, 2023”, and the current date is “Aug. 1, 2023.” In this case, the market price acquirer 102 calculates the difference between the selling price of “3200 yen” and the market price of the used similar product of “2800 yen”, and divides the difference by a number of days “200” from the release date of “Jan. 14, 2023” to the current date of “Aug. 1, 2023” to obtain a daily depreciation rate of “2.0”. Moreover, since “60 days” have passed from the date of “Jun. 3, 2023” on which the user U2 purchased the product P2 to the current date of “Aug. 1, 2023”, the market price acquirer 102 sets, as the market price of the used similar product, a value of “2880 yen”, which is obtained by subtracting, from the price of “3000 yen” at which the user U2 purchased the product P2, a value obtained by multiplying the number of days of “60” by the depreciation rate of “2.0”. The market price acquirer 102 regards the corrected market price of “2880 yen” of the used similar product as the market price of the used product of the product P2.

The outputter 103 outputs a message prompting the user to list, in electronic flea market, the product included in the acquired purchase history at the acquired market price of the used product.

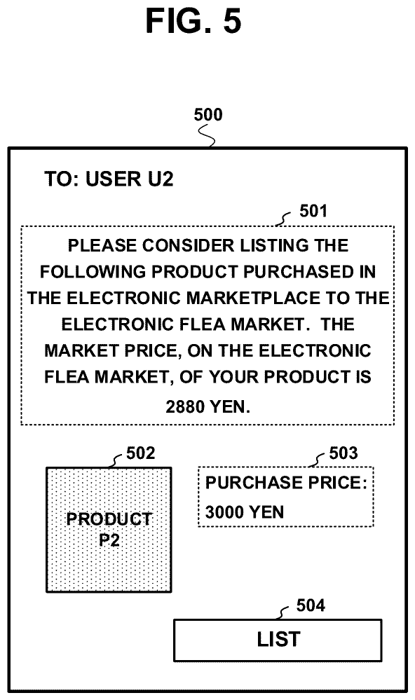

FIG. 5 illustrates an example of the message that is output. A message 500 includes text 501 in which the acquired market price of the used product is written, an image 502 of the product purchased by the user in the electronic marketplace, information 503 about the purchase price of the product purchased by the user, and a button 504 for listing the product purchased by the user in the electronic flea market. Note that a configuration is possible in which the information about the purchase date is displayed together with the information about the purchase price. In one example, the message 500 of FIG. 5 is sent to an email address of the user U2 and is displayed on a screen of the user terminal 300. The market price of the product P2 written in the text 501 is the corrected market price of the used similar product of the similar product P3 that is similar to the product P2. The user U2 can determine whether to list the product P2 by referencing the market price of the product P2 written in the text 501. When the user U2 selects the button 504, the display transitions to a listing procedure page provided by the electronic flea market server 100.

### 4. Operations of Management Processing of Electronic Flea Market Server of the Embodiment

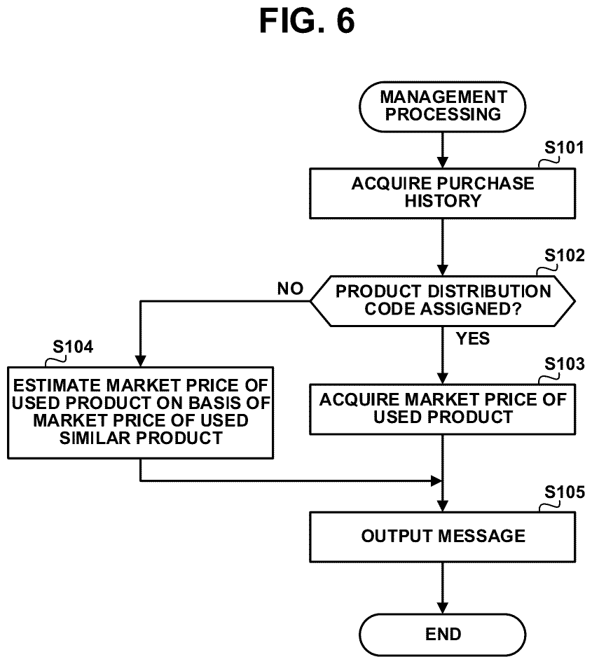

The management processing performed by the electronic flea market server 100 of the present embodiment is described using FIG. 6. The management processing of FIG. 6 starts at an arbitrary timing set by an administrator of the electronic flea market server 100.

The purchase history acquirer 101 acquires, from the electronic marketplace server 200 that manages the electronic marketplace, a purchase history of a product that the user has purchased on the electronic marketplace (step S101). Next, the market price acquirer 102 determines whether a product distribution code is assigned to the product included in the acquired purchase history (step S102).

For example, the purchase history acquirer 101 acquires, from the electronic marketplace server 200, a purchase history of a user that purchased the product on the purchase date “Jun. 3, 2023”, and registers the information of the acquired purchase history in the purchase history table. Next, the market price acquirer 102 determines whether the product distribution code is assigned to the product included in the purchase history of the purchase date of “Jun. 3, 2023.”

In a case in which a determination is made that the product distribution code is assigned to the product included in the acquired purchase history (step S102; YES), the market price acquirer 102 acquires, on the basis of the assigned product distribution code, the market price of a used product of the product included in the acquired purchase history (step S103). Meanwhile, in a case in which a determination is made that the product distribution code is not assigned to the product included in the acquired purchase history (step S102; NO), the market price acquirer 102 acquires the product distribution code assigned to a similar product that is similar to the product included in the acquired purchase history, acquires, on the basis of the acquired product distribution code, the market price of a used similar product that is a used item of the similar product, and estimates, on the basis of the acquired market price of the used similar product, the market price of the used product of the product included in the acquired purchase history (step S104).

In one example, the product distribution code “xxxx-xxxx” is assigned for the product P1 included in the purchase history of the user U1 and, as such, the market price acquirer 102 searches, in the electronic flea market, for a used product of the product P1 to which the product distribution code “xxxx-xxxx” is assigned. Then, the market price acquirer 102 acquires, as the market price of the used product of the product P1, a mean of the prices at which transactions have been made for the used product of the product P1 specified by the searching. Meanwhile, the product distribution code is not assigned to the product P2 included in the purchase history of the user U2 and, as such, the market price acquirer 102 searches, in the electronic flea market, for a used similar product of the similar product P3 to which the product distribution code “yyyy-yyyy” is assigned. Then, the market price acquirer 102 acquires, as the market price of the used similar product of the similar product P3, a mean of the prices at which transactions have been made for the used similar product of the similar product P3 specified by the searching, and regards the market price of the used similar product of the similar product P3 as the market price of the used product of the product P2.

The outputter 103 outputs a message prompting the user to list, in electronic flea market, the product included in the acquired purchase history at the acquired market price of the used product (step S105).

In one example, the outputter 103 sends the message 500 of FIG. 5 to the email address of the user U2.

According to the present disclosure, even for products to which a product distribution code is not assigned that are sold on an electronic marketplace, it is possible to estimate the market price in an electronic flea market, and present, to the user, the market price in the electronic flea market of the product purchased on the electronic marketplace. As a result, it is possible to perform prompting of listing in the electronic flea market for various products purchased by the user on the electronic marketplace.

Additionally, according to the present embodiment, it is possible to correct the market price on the basis of the purchase price and the purchase date at which the user purchased the product on the electronic marketplace. As a result, it is possible to obtain a market price reflecting the circumstances under which the user purchased the product on the electronic marketplace.

### 6. Modified Examples

An embodiment of the present disclosure is described above. However, various modifications and applications are possible when implementing the present disclosure.

In the embodiment described above, the selling price of the new item is set as a current selling price of the new item on the electronic marketplace, but the present disclosure is not limited thereto. A configuration is possible in which the selling price of the new item is set as a past selling price of the new item on the electronic marketplace, for example, as the selling price on the release date.

In the embodiment described above, the depreciation rate estimated by the market price acquirer 102 is set as a daily depreciation rate, but the present disclosure is not limited thereto. For example, a configuration is possible in which the depreciation rate is obtained by using the straight-line method in which the same amount is depreciated every year, or the declining balance method in which the same depreciation rate is used every year. Additionally, a configuration is possible in which, when correcting the acquired market price of the used product and the acquired market price of the used similar product on the basis of the estimated depreciation rate, the purchase price, and the purchase date, the market price acquirer 102 sets a lower limit for the market price of the used product and the market price of the used similar product. As a result, it is possible to obtain the market price in consideration of the transaction conditions of each product, such as the price only decreasing to a certain level, even for used items.

In the embodiment described above, the outputter 103 sends the message 500 to the user terminal 300, but the present disclosure is not limited thereto. For example, a configuration is possible in which, upon the user logging into a website of the electronic flea market or the electronic marketplace, the outputter 103 displays a message including the market price of a product purchased by the user on a screen.

A program defining the operations of the electronic flea market server 100 according to the embodiment described above can be applied to an existing personal computer or information terminal device to cause that personal computer or information terminal device to function as the electronic flea market server 100 according to the embodiment.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

According to the present disclosure, an electronic flea market server, a management method, and a recording medium can be provided whereby it is possible to estimate the market price in an electronic flea market of a product that is purchased on an electronic marketplace and to which a product distribution code is not assigned, and to prompt listing of that product in the electronic flea market.

1. An electronic flea market server that manages an electronic flea market, the electronic flea market server comprising one or more processors, the one or more processors performing processing of:
acquiring, from an electronic marketplace server that manages an electronic marketplace, a purchase history of a product purchased by a user on the electronic marketplace;
acquiring a market price, in the electronic flea market, of a used product that is a used item of the product included in the acquired purchase history;
outputting a message prompting the user to list, in the electronic flea market, the product included in the acquired purchase history at the acquired market price of the used product; and
in a case in which a product distribution code is not assigned to the product included in the acquired purchase history,
acquiring, from the electronic marketplace server, a product distribution code assigned to a similar product that is similar to the product included in the acquired purchase history, acquiring, based on the acquired product distribution code, a market price of a used similar product that is a used item of the similar product, and estimating, based on the acquired market price of the used similar product, the market price of the used product of the product included in the acquired purchase history.

2. The electronic flea market server according to claim 1, wherein the one or more processors performs processing of:
in a case in which the product distribution code is assigned to the product included in the acquired purchase history,
acquiring, based on the assigned product distribution code, the market price of the used product of the product included in the acquired purchase history.

3. The electronic flea market server according to claim 2, wherein the one or more processors performs processing of:
in a case in which the product distribution code is assigned to the product purchased by the user on the electronic marketplace,
acquiring, from the electronic marketplace server, a purchase history including the assigned product distribution code, and information about a purchase price and a purchase date of the product purchased by the user on the electronic marketplace, and
in a case in which the product distribution code is not assigned to the product purchased by the user on the electronic marketplace,
acquiring, from the electronic marketplace server, a purchase history including the product distribution code assigned to the similar product that is similar to the product purchased by the user on the electronic marketplace, and the information about the purchase price and the purchase date of the product purchased by the user on the electronic marketplace.

4. The electronic flea market server according to claim 3, wherein the one or more processors performs processing of:
in a case in which the product distribution code is assigned to the product included in the acquired purchase history,
correcting, based on the purchase price and the purchase date, the acquired market price of the used product, and
in a case in which the product distribution code is not assigned to the product included in the acquired purchase history,
correcting, based on the purchase price and the purchase date, the acquired market price of the used similar product.

5. The electronic flea market server according to claim 4, wherein the one or more processors performs processing of:
estimating a depreciation rate based on a selling price, in the electronic marketplace, of a new item of the product included in the acquired purchase history and the acquired market price of the used product, and
correcting the acquired market price of the used product based on the estimated depreciation rate, the purchase price, and the purchase date.

6. The electronic flea market server according to claim 4, wherein the one or more processors performs processing of:
estimating a depreciation rate based on a selling price, in the electronic marketplace, of a new item of the similar product that is similar to the product included in the acquired purchase history and the acquired market price of the used similar product, and
correcting the acquired market price of the used similar product based on the estimated depreciation rate, the purchase price, and the purchase date.

7. A management method that an electronic flea market server that manages an electronic flea market performs, the method comprising:
acquiring, from an electronic marketplace server that manages an electronic marketplace, a purchase history of a product purchased by a user on the electronic marketplace;
acquiring a market price, in the electronic flea market, of a used product that is a used item of the product included in the acquired purchase history; and
outputting a message prompting the user to list, in the electronic flea market, the product included in the acquired purchase history at the acquired market price of the used product, wherein
in the acquiring of the market price,
in a case in which a product distribution code is not assigned to the product included in the acquired purchase history,
a product distribution code assigned to a similar product that is similar to the product included in the acquired purchase history is acquired from the electronic marketplace server, a market price of a used similar product that is a used item of the similar product is acquired based on the acquired product distribution code, and the market price of the used product of the product included in the acquired purchase history is estimated based on the acquired market price of the used similar product.

8. A non-transitory computer-readable recording medium on which is recorded a program for causing a computer that manages an electronic flea market to perform:
acquiring, from an electronic marketplace server that manages an electronic marketplace, a purchase history of a product purchased by a user on the electronic marketplace;
acquiring a market price, in the electronic flea market, of a used product that is a used item of the product included in the acquired purchase history;
outputting a message prompting the user to list, in the electronic flea market, the product included in the acquired purchase history at the acquired market price of the used product; and
in a case in which a product distribution code is not assigned to the product included in the acquired purchase history,
acquiring, from the electronic marketplace server, a product distribution code assigned to a similar product that is similar to the product included in the acquired purchase history, acquiring, based on the acquired product distribution code, a market price of a used similar product that is a used item of the similar product, and estimating, based on the acquired market price of the used similar product, the market price of the used product of the product included in the acquired purchase history.
